(19) United States
(12) Patent Application Publication
(10) Pub. No.: US 2008/0278673 A1
(43) Pub. Date: Nov. 13, 2008

(54) Polarizer, Polarizing Plate Optical Film and Image Display

(75) Inventors: Masahiro Yoshioka, Osaka (JP); Minoru Miyatake, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/547,139

(22) PCT Filed: Mar. 18, 2005
(86) PCT No.: PCT/JP2005/004961

§ 371 Date: Oct. 4, 2006

(30) Foreign Application Priority Data
Apr. 5, 2004 (JP) 2004-000212

(51) Int. Cl. G02B 5/30

(52) U.S. Cl. 349/194

(57) ABSTRACT

A polarizer of the invention comprises: a film that has a structure having at least two types of minute domains dispersed in a matrix formed of an optically-transparent water-soluble resin, wherein at least one of the minute domains is formed of a liquid-crystalline birefringent material, and at least one of the other type or types of the minute domains is formed of a polyvinyl alcohol resin material containing a dichroic light-absorbing material that does not lose its dichroism within the liquid crystal temperature range of the liquid-crystalline birefringent material. The polarizer has good heat resistance and a high polarization degree and a high transmittance such that unevenness in transmittance can be suppressed when black viewing is displayed.

### TECHNICAL FIELD

The present invention relates to a polarizer. This invention also relates to a polarizing plate and an optical film using the polarizer concerned. Furthermore, this invention relates to an image display, such as a liquid crystal display, an organic electroluminescence display, a CRT and a PDP using the polarizing plate and the optical film concerned.

### BACKGROUND ART

Liquid crystal display are rapidly developing in market, such as in clocks and watches, cellular phones, PDAs, notebook-sized personal computers, and monitor for personal computers, DVD players, TVs, etc. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

As polarizers, for example, since it has a high transmittance and a high polarization degree, polyvinyl alcohols having a structure in which iodine is absorbed and then stretched, that is, iodine based polarizers are widely used (for example, Japanese Patent Laid-Open (JP-A) No. 2001-296427). However, since the iodine based polarizers have relatively low polarization degrees in short wavelength side, they have problems in hue, such as blue omission in black viewing, and yellowing in white viewing, in short wavelength side.

Iodine based polarizers may easily give unevenness in a process of iodine absorption. Accordingly, there has been a problem that the unevenness is detected as unevenness in transmittance particularly in the case of black viewing, causing to decrease of visibility. For example, as methods for solving the problems, several methods have been proposed that an amount of absorption of iodine absorbed to the iodine based polarizer is increased and thereby a transmittance in the case of black viewing is set not higher than sensing limitations of human eyes, and that stretching processes generating little unevenness itself are adopted. However, the former method has a problem that it decreases a transmittance in the case of white viewing, while decreasing a transmittance of black viewing, and as a result darkens the display itself. And also, the latter method has a problem that it requires replacing a process itself, worsening productivity.

On the other hand, dye based polarizers have been used that employ dichroic dyes in stead of the iodine compound (for example, see JP-A No. 62-123405). Such polarizers have improved heat resistance and are proposed as an alternative to the iodine based polarizers, which cannot be used for products intended for outdoor use, such as cellular phones and PDAs, or products expected to be used at high temperatures, such as car navigation systems and liquid crystal projectors, because in the iodine based polarizers, iodine can sublime or the polarized light separating function can be reduced by a change in the state of the coordination complex. However, dichroic dyes have lower absorption dichroic ratios than iodine compounds. Thus, the compatibility between light transmittance and polarization degree is lower in the dye based polarizers than in the iodine based polarizers. Specifically, if light transmittance is preferentially increased by reducing the concentration of a dichroic dye, the contrast can be reduced. If the concentration is increased, the contrast can be increased but the light transmittance can be reduced so that the brightness can be reduced. A good balance between light transmittance and polarization degree, which can be achieved with the iodine based polarizers, is difficult to achieve with the dye based polarizers.

To solve these problems, there is disclosed a polarizer in which a mixed phase of a liquid-crystalline birefringent material and a dichroic dye is dispersed in a resin matrix (see JP-A No. 2002-207118). In this polarizer, a polarized light whose direction absorbed into the dichroic dye is scattered so that the polarized light absorption efficiency can be increased and that a good balance can be achieved between light transmittance and polarization degree. According to the Patent Literature, the dichroic dye is previously added to the liquid-crystalline birefringent material, which is dispersed to form minute domains, and the dichroic dye is oriented in the minute domains. However, its orientation-regulating force is weaker than the orientation-regulating force of stretched polyvinyl alcohol acting on the iodine complex in the iodine based polarizer, and therefore the intrinsic dichroism of the dichroic dye cannot be sufficiently exerted so that the degree of improvement in the properties of the polarizer is limited.

### DISCLOSURE OF INVENTION

This invention aims at providing aims at providing a polarizer that has good heat resistance and a high polarization degree and a high transmittance such that unevenness in transmittance can be suppressed when black viewing is displayed.

Besides, this invention aims at providing a polarizing plate and an optical film using the polarizer. Furthermore this invention aims at providing an image display using the elliptically polarizing plate or the optical film.

As a result of examination wholeheartedly performed by the present inventors that the above-mentioned subject should be solved, it was found out that the above-mentioned purpose is attained using polarizers shown below, leading to completion of this invention.

That is, this invention relates to a polarizer, comprising: a film that has a structure having at least two types of minute domains dispersed in a matrix formed of an optically-transparent water-soluble resin, wherein

at least one of the minute domains is formed of a liquid-crystalline birefringent material, and

at least one of the other type or types of the minute domains is formed of a polyvinyl alcohol resin material containing a dichroic light-absorbing material that does not lose its dichroism within the liquid crystal temperature range of the liquid-crystalline birefringent material.

The liquid-crystalline birefringent material forming the minute domain is preferred to orient. And the liquid-crystalline birefringent material preferably shows liquid crystalline at least in orientation processing step.

The polarizer of the invention includes: a matrix formed of an optically-transparent resin; and at least two types of minute domains dispersed in the matrix. At least one of the minute domains is made of a liquid-crystalline birefringent material, and at least one of the other type or types of the minute domains are made of a polyvinyl alcohol resin material containing a dichroic light-absorbing material. Thus, the absorptive dichroism function of the dichroic light-absorbing material is combined with the scattering anisotropy function so that a synergistic effect of the two functions can improve the polarization performance. Accordingly, there is provided a polarizer that has good visibility and a good balance between transmittance and polarization degree. In addition, the dichroic light-absorbing material does not lose its dichroism within the liquid crystal temperature range, and therefore the polarizer that contains the dichroic light-absorbing material in the minute domains has good heat resistance.

Scattering performance of anisotropic scattering originates in refractive index difference between matrixes and minute domains. Since the liquid-crystalline birefringent material forming the minute domain have higher wavelength dispersion of Δn compared with optically-transparent water-soluble resins as a matrix, a refractive index difference in scattering axis becomes larger in shorter wavelength side, and, as a result, it provides more amounts of scattering in shorter wavelength and thus, as a whole, a polarizer having high polarization and neutral hue may be realized. Especially, an iodine based polarizer containing iodine as the dichroic light-absorbing material has relatively low polarization function in a side of shorter wavelength; thereby a large improving effect of polarization performance and neutralization is obtained

In the above-mentioned polarizer, it is preferable that the liquid-crystalline birefringent materials have a birefringence of 0.02 or more. In liquid-crystalline birefringent materials used for minute domains, in the view point of gaining larger anisotropic scattering function, materials having the above-mentioned birefringence may be preferably used.

In the above-mentioned polarizer, in a refractive index difference between the liquid-crystalline birefringent material forming the minute domains and the optically-transparent water-soluble resin in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹

Control of the above-mentioned refractive index difference (Δn¹) and (Δn²) in each optical axis direction into the above-mentioned range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, and it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in an Δn¹ direction is set 0.03 or more, preferably 0.05 or more, and still preferably 0.10 or more. A refractive index difference (Δn²) in two directions perpendicular to the Δn¹ direction is 50% or less of the above-mentioned Δn¹, and preferably 30% or less.

In the above-mentioned polarizer, an absorption axis of the dichroic light-absorbing material contained in the polyvinyl alcohol resin material forming the minute domain is preferably oriented in the Δn¹ direction.

The dichroic light-absorbing material in the polyvinyl alcohol resin material is orientated so that an absorption axis of the material may become parallel to the above-mentioned Δn¹ direction, and thereby linearly polarized light in the Δn¹ direction as a scattering polarizing direction may be selectively absorbed. As a result, on one hand, a linearly polarized light component of incident light in an Δn² direction is transmitted without scattering by the dichroic light-absorbing material as in conventional polarizers without anisotropic scattering performance. On the other hand, a linearly polarized light component in the Δn¹ direction is scattered, and is absorbed by the dichroic light-absorbing material. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional polarizers. That is, higher polarization degrees may be attained with same transmittances.

Descriptions for ideal models will, hereinafter, be given. Two main transmittances usually used for linear polarizer (a first main transmittance k₁ (a maximum transmission direction=linearly polarized light transmittance in an Δn² direction), a second main transmittance k₂ (a minimum transmission direction linearly polarized light transmittance in an Δn¹ direction)) are, hereinafter, used to give discussion.

In commercially available iodine based polarizers, when the dichroic light-absorbing materials (iodine based light absorbing materials) are oriented in one direction, a parallel transmittance and a polarization degree may be represented as follows, respectively:

parallel transmittance=0.5×((k₁)²+(k₂)²) and

polarization degree=(k₁−k₂)/(k₁+k₂).

On the other hand, when it is assumed that, in a polarizer of this invention, a polarized light in a Δn¹ direction is scattered and an average optical path length is increased by a factor of α (>1), and depolarization by scattering may be ignored, main transmittances in this case may be represented as k₁ and k₂′=10^{x} (where, x is αlogk₂), respectively That is, a parallel transmittance in this case and the polarization degree are represented as follows:

parallel transmittance=0.5×((k₁)²+(k₂′)²) and

polarization degree=(k₁−k₂′)/(k₁+k₂′).

When a polarizer of this invention is prepared by a same condition (an amount of dyeing and production procedure are same) as in commercially available iodine based polarizers (parallel transmittance 0.385, polarization degree 0.965: k₁=0.877, k₂=0.016), on calculation, when a is 2 times, k₂ becomes small reaching 0.0003, and as result, a polarization degree improves up to 0.999, while a parallel transmittance is maintained as 0.385. The above-mentioned result is on calculation, and function may decrease a little by effect of depolarization caused by scattering, surface reflection, backscattering, etc. As the above-mentioned equations show, higher value a may give better results and higher dichroic ratio of the dichroic light-absorbing material may provide higher function. In order to obtain higher value α, a highest possible scattering anisotropy function may be realized and polarized light in an Δn¹ direction may just be selectively and strongly scattered. Besides, less backscattering is preferable, and a ratio of backscattering strength to incident light strength is preferably 30% or less, and more preferably 20% or less.

As the above-mentioned polarizers, films manufactured by stretching may suitably be used.

In the above-mentioned polarizer, minute domains preferably have a length in an Δn² direction of 0.05 to 500 μm.

In order to scatter strongly linearly polarized light having a plane of vibration in a Δn¹ direction in wavelengths of visible light band, dispersed minute domains have a length controlled to 0.05 to 500 μm in a Δn² direction, and preferably controlled to 0.5 to 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully oriented in the minute domains may arise.

In the above-mentioned polarizer, the dichroic light-absorbing materials having an absorption band at least in a wavelength range of 400 to 700 nm may be used.

In the above-mentioned polarizers, a transmittance to a linearly polarized light in a transmission direction is 70% or more, a haze value is 10% or less, and a haze value to a linearly polarized light in an absorption direction is 50% or more.

A polarizer of this invention having the above-mentioned transmittance and haze value has a high transmittance and excellent visibility for linearly polarized light in a transmission direction, and has strong optical diffusibility for linearly polarized light in an absorption direction. Therefore, without sacrificing other optical properties and using a simple method, it may demonstrate a high transmittance and a high polarization degree, and may control unevenness of the transmittance in the case of black viewing.

As a polarizer of this invention, a polarizer is preferable that has as high as possible transmittance to linearly polarized light in a transmission direction, that is, linearly polarized light in a direction perpendicular to a direction of maximal absorption of the above-mentioned dichroic light-absorbing material, and that has 70% or more of light transmittance when an optical intensity of incident linearly polarized light is set to 100. The light transmittance is preferably 75% or more, and still preferably 80% or more. Here, a light transmittance is equivalent to a value Y calculated from a spectral transmittance in 380 nm to 780 nm measured using a spectrophotometer with an integrating sphere based on CIE 1931 XYZ standard calorimetric system. In addition, since about 8% to 10% is reflected by an air interface on a front surface and rear surface of a polarizer, an ideal limit is a value in which a part for this surface reflection is deducted from 100%.

It is desirable that a polarizer does not scatter linearly polarized light in a transmission direction in the view point of obtaining clear visibility of a display image. Accordingly, the polarizer preferably has 10% or less of haze value to the linearly polarized light in the transmission direction, more preferably 8% or less, and still more preferably 5% or less. On the other hand, in the view point of covering unevenness by a local transmittance variation by scattering, a polarizer desirably scatters strongly linearly polarized light in an absorption direction, that is, linearly polarized light in a direction for a maximal absorption of the above-mentioned dichroic light-absorbing material. Accordingly, a haze value to the linearly polarized light in the absorption direction is preferably 30% or more, more preferably 40% or more, and still more preferably 50% or more. In addition, the haze value here is measured based on JIS K 7136 (how to obtain a haze of plastics-transparent material).

The above-mentioned optical properties are obtained by compounding a function of scattering anisotropy with a function of an absorption dichroism of the polarizer. As is indicated in U.S. Pat. No. 2,123,902 specification, Japanese Patent Laid-Open No. 9-274108, and Japanese Patent Laid-Open No. 9-297204, same characteristics may probably be attained also in a way that a scattering anisotropic film having a function to selectively scatter only linearly polarized light, and a dichroism absorption type polarizer are superimposed in an axial arrangement so that an axis providing a greatest scattering and an axis providing a greatest absorption may be parallel to each other. These methods, however, require necessity for separate formation of a scattering anisotropic film, have a problem of precision in axial joint in case of superposition, and furthermore, a simple superposition method does not provide increase in effect of the above-mentioned optical path length of the polarized light absorbed as is expected, and as a result, the method cannot easily attain a high transmission and a high polarization degree.

Besides, this invention relates to a polarizing plate in which a transparent protective layer is not prepared on the above-mentioned polarizer.

Besides, this invention relates to a polarizing plate in which a transparent protective layer is prepared at least on one side of the above-mentioned polarizer.

Moreover, this invention relates to an optical film characterized by being laminated with at least one of the above-mentioned polarizer and the above-mentioned polarizing plate.

Furthermore, this invention relates to an image display characterized by using the above-mentioned polarizer, the above-mentioned polarizing plate, or the above-mentioned optical film.

### BRIEF DESCRIPTION OF DRAWING

FIG. 1 is conceptual view showing an example of a polarizer of this invention.

### BEST MODE FOR CARRYING OUT THE INVENTION

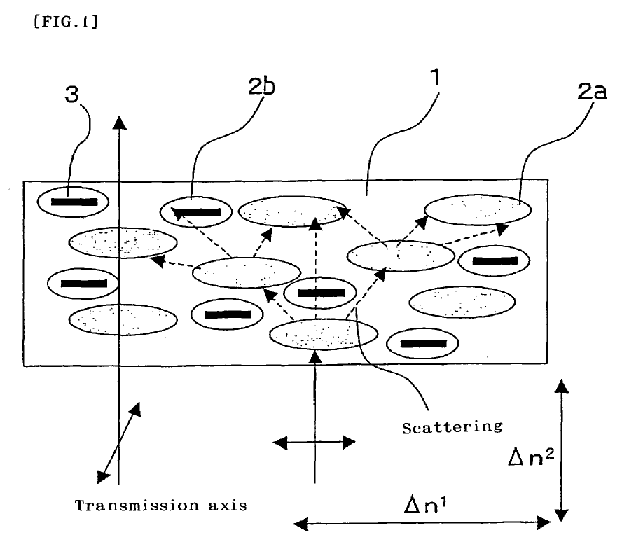

The polarizer of the invention is described below with reference to the drawing. FIG. 1 is a conceptual view of the polarizer of the invention. Referring to FIG. 1, optically-transparent resin 1 forms a film. The polarizer has a structure that includes a matrix of the film and at least two types of minute domains 2 dispersed in the matrix. At least one of the at least two types of the minute domains 2 are minute domains 2a that are made of a liquid-crystalline birefringent material, while at least one of the other type or types of the minute domains 2 are minute domains 2b that are made of a polyvinyl alcohol resin material containing a dichroic light-absorbing material 3. Alternatively, the dichroic light-absorbing material 3 may be dispersed in the optically-transparent resin 1 that forms the matrix.

FIG. 1 shows an example where the dichroic light-absorbing material 3 contained in the minute domains 2b is aligned in a certain axis direction (Δn¹ direction) where the difference between the refractive indices of the minute domain 2a and the optically-transparent resin 1 is maxim. In the minute domains 2a, the polarized light component in the Δn¹ direction is scattered. In FIG. 1, the Δn¹ direction, which is a direction in the film plane, is the direction of the absorption axis. A Δn² direction perpendicular to the Δn¹ direction in the film plane is the direction of the transmission axis. Another Δn² direction orthogonal to the Δn¹ direction is the thickness direction.

The optically-transparent resin 1 has light-transmitting properties in the visible light range and may be any material in which the dichroic light-absorbing material can be dispersed and adsorbed. The optically-transparent resin 1 may be an optically-transparent water-soluble resin. Since a polyvinyl alcohol resin is dispersed as the minute domain 2b, materials other than the polyvinyl alcohol resin should be used for the optically-transparent resin 1. The matrix using materials other than the polyvinyl alcohol resin can have good heat resistance and good moisture resistance. In particular, the matrix using a resin that is not water-soluble can have good heat resistance and good moisture resistance. Examples of the optically-transparent resin 1 include water-soluble resins such as polyvinylpyrrolidone resins and amylose resins. Examples of the optically-transparent resin 1 also include polyester resins such as polyethylene terephthalate and polyethylene naphthalate; styrene resins such as polystyrene and acrylonitrile-styrene copolymers (AS resins); and olefin resins such as polyethylene, polypropylene, cyclo type- or norbornene structure-containing polyolefins, and ethylene-propylene copolymers. Examples thereof also include vinyl chloride resins, cellulose resins, acrylic resins, amide resins, imide resins, sulfone polymers, polyethersulfone resins, polyetheretherketone rein polymers, polyphenylene sulfide resins, vinylidene chloride resins, vinyl butyral resins, arylate resins, polyoxymethylene resins, silicone resins, and urethane resins. Among these resins, extrudable resins are preferably used. The optically-transparent resin 1 may be isotropic so as to hardly cause orientation birefringence by forming strain or may be anisotropic so as to easily cause orientation birefringence.

A liquid-crystalline birefringent material is used to form the minute domain 2a. The liquid-crystalline birefringent material showing liquid crystallinity at least in orientation processing step is preferably used. That is, the liquid crystalline material may show or may lose liquid crystallinity in the formed minute domain 2a, as long as it shows liquid crystallinity at the orientation treatment time.

As the liquid-crystalline birefringent materials forming the minute domains 2a may be any of materials showing nematic liquid crystallinity, smectic liquid crystallinity, and cholesteric liquid crystallinity, or of materials showing lyotropic liquid crystallinity. Moreover, materials having birefringence may be of liquid crystalline thermoplastic resins, and may be formed by polymerization of liquid crystalline monomers. When the liquid-crystalline birefringent material is of liquid crystalline thermoplastic resins, in the view point of heat-resistance of structures finally obtained, resins with high glass transition temperatures may be preferable. Furthermore, it is preferable to use materials showing glass state at least at room temperatures. Usually, a liquid crystalline thermoplastic resin is oriented by heating, subsequently cooled to be fixed, and forms the minute domains 2a while liquid crystallinity is maintained. Although liquid crystalline monomers after orienting can form the minute domains 2a in the state of fixed by polymerization, cross-linking, etc., some of the formed the minute domains 2a may lose liquid crystallinity.

As the above-mentioned liquid crystalline thermoplastic resins, polymers having various skeletons of principal chain types, side chain types, or compounded types thereof may be used without particular limitation. As principal chain type liquid crystal polymers, polymers, such as condensed polymers having structures where mesogen groups including aromatic units etc. are combined, for example, polyester based, polyamide based, polycarbonate based, and polyester imide based polymers, may be mentioned. As the above-mentioned aromatic units used as mesogen groups, phenyl based, biphenyl based, and naphthalene based units may be mentioned, and the aromatic units may have substituents, such as cyano groups, alkyl groups, alkoxy groups, and halogen groups.

As side chain type liquid crystal polymers, polymers having principal chain of, such as polyacrylate based, polymethacrylate based, poly-alpha-halo acrylate based, poly-alpha-halo cyano acrylate based, polyacrylamide based, polysiloxane based, and poly malonate based principal chain as a skeleton, and having mesogen groups including cyclic units etc. in side chains may be mentioned.

As the above-mentioned cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 to 20, preferably 2 to 12, and the number of repeating units of polyoxymethylene chain is 0 to 10, and preferably 1 to 3.

The above-mentioned liquid crystalline thermoplastic resins preferably have glass transition temperatures of 50° C. or more, and more preferably 80° C. or more. Furthermore they have approximately 2,000 to 100,000 of weight average molecular weight.

As liquid crystalline monomers, monomers having polymerizable functional groups, such as acryloyl groups and methacryloyl groups, at terminal groups, and further having mesogen groups and spacer parts including the above-mentioned cyclic units etc. may be mentioned. Crossed-linked structures may be introduced using polymerizable functional groups having two or more acryloyl groups, methacryloyl groups, etc., and durability may also be improved.

Materials forming the minute domains 2a are not entirely limited to the above-mentioned liquid-crystalline birefringent materials, and non-liquid crystalline resins may be used if they are different materials from the matrix materials. As the above-mentioned resins, polyvinyl alcohols and derivatives thereof, polyolefins, polyarylates, polymethacrylates, polyacrylamides, polyethylene terephthalates, acrylic styrene copolymes, etc. may be mentioned. Moreover, particles without birefringence may be used as materials for forming the minute domains 2a. As fine-particles concerned, resins, such as polyacrylates and acrylic styrene copolymers, may be mentioned. A size of the fine-particles is not especially limited, and particle diameters of 0.05 to 500 μm may be used, and preferably 0.5 to 100 μm. Although it is preferable that materials for forming the minute domains 2a is of the above-mentioned liquid-crystalline birefringent materials, non-liquid crystalline materials may be mixed and used to the above-mentioned liquid-crystalline birefringent materials. Furthermore, as materials for forming minute domains 2a, non-liquid crystalline materials may also be independently used.

The minute domains 2b are formed of a polyvinyl alcohol resin material containing the dichroic light-absorbing material 3. Any polyvinyl alcohol resin material that can be dyed with the dichroic light-absorbing material 3 may be used for the minute domains 2b without limitation. Examples thereof include polyvinyl alcohol and derivatives thereof which are conventionally used for polarizers. As derivatives of polyvinyl alcohol, polyvinyl formals, polyvinyl acetals, etc. may be mentioned, and in addition derivatives modified with olefins, such as ethylene and propylene, and unsaturated carboxylic acids, such as acrylic acid, methacrylic acid, and crotonic acid, alkyl esters of unsaturated carboxylic acids, acrylamides etc. may be mentioned.

Preferably, the dichroic light-absorbing material 3 to be used has heat resistance and does not lose its dichroism due to decomposition or deterioration even when the liquid-crystalline birefringent material that forms the minute domains 2a is heated to be aligned within the liquid crystal temperature range. Examples of the dichroic light-absorbing material 3 having such properties include iodine light-absorbing materials and absorbing dichroic dyes or pigments.

Absorbing dichroic dyes that are conventionally added to polyvinyl alcohol resins to produce dichroism are preferably used. For example, the dichroic dyes disclosed in JP-A Nos. 05-296281, 05-295282, 05-311086, 06-122830, 06-128498, 07-3172, 08-67824, 08-73762, and 08-127727 may be used without limitation. Also preferably used are the dichroic dyes disclosed in JP-A Nos. 05-53014, 05-53015, 06-122831, 06-265723, 06-337312, 07-159615, 07-318728, 07-325215, 07-325220, 08-225750, 08-291259, 08-302219, 09-73015, 09-132726, 09-302249, 09-302250, 10-259311, 2000-319633, 2000-327936, 2001-2631, 2001-4833, 2001-108828, 2001-240762, 2002-105348, 2002-155218, 2002-179937, 2002-220544, 2002-275381, 2002-357719, 2003-64276, 02-13903, 02-89008, 03-89203, 2003-313451, and 2003-327858, and the dichroic dyes disclosed in JP-A Nos. 09-230142, 11-218610, 11-218611, 2001-27708, 2001-33627, 2001-56412, 2002-296417, 01-313568, 03-12606, and 2003-215338, and the brochure of WO00/37973. It will be understood that the absorbing dichroic dye for use in the invention is not limited to these materials and any other materials with which the polyvinyl alcohol resin can be dyed may also be preferably used.

The polarizer of the invention may comprise: a film that is prepared to form a matrix of the optically-transparent resin 1; minute domains 2b that are formed of the polyvinyl alcohol resin material, dispersed in the matrix and contain the dichroic light-absorbing material 3; and minute domains 2a that are formed of the liquid-crystalline birefringent material and dispersed in the matrix. In the film, the refractive index difference (Δn¹) in the Δn¹ direction and the refractive index difference (Δn²) in the Δn² direction may each be controlled to be within the above range.

While the polarizer of the invention may be prepared by any method, it may be typically prepared by a process including the processes of:

(1) preparing a mixed solution or a molten resin that includes an optically-transparent resin for forming a matrix, a liquid-crystalline birefringent material for forming minute domains, and a polyvinyl alcohol material that is for forming minute domains and optionally dyed with a dichroic light-absorbing material, wherein the birefringent material and the polyvinyl alcohol material are dispersed in the resin;
(2) forming the mixed solution or the molten resin of the process (1) into a film; and
(3) orienting (stretching) the film obtained in the process (2); and
(4) optionally dispersing (or dyeing) a dichroic light-absorbing material into the polyvinyl alcohol resin material forming minute domains, if the dichroic light-absorbing material is not added in the process (1). The processes (1) to (4) may be performed in any appropriate order.

In the process (1), the liquid-crystalline birefringent material for forming minute domains and the polyvinyl alcohol material that is for forming minute domains and dyed with the dichroic light-absorbing material are first dispersed into the optically-transparent resin for forming a matrix to form the mixed solution or the molten resin.

In the case where the mixed solution is prepared, the method of preparation is typically, but not limited to, a method using the phenomenon of phase separation between the matrix component (optically-transparent resin), the liquid-crystalline birefringent material and the polyvinyl alcohol material. For example, such a method includes selecting a liquid-crystalline birefringent material and a polyvinyl alcohol material that are hardly compatible with the matrix component and dispersing, with a dispersing agent such as a surfactant, a solution of the liquid-crystalline birefringent material and the polyvinyl alcohol material into a solution of the matrix component. In the case where the dichroic light-absorbing material is also dispersed, the method of preparation may be a method of simultaneously mixing the material for forming the matrix, the liquid-crystalline birefringent material, and the polyvinyl alcohol material and the dichroic light-absorbing material or may be a method including the processes of previously dispersing the dichroic light-absorbing material into the polyvinyl alcohol resin material and then mixing the dispersion with the material for forming the matrix and the liquid-crystalline birefringent material. It will be understood that the method of preparation is not limited to these methods and may be any other appropriate method.

In the case where the molten resin is prepared in the process (1), the method of preparation is typically, but not limited to, a method using the phenomenon of phase separation between the matrix component, the liquid-crystalline birefringent material and the polyvinyl alcohol material. For example, such a method includes selecting a liquid-crystalline birefringent material and a polyvinyl alcohol material that are hardly compatible with the matrix component and melting and dispersing or kneading, with the aid of a dispersing agent such as a surfactant, a solution of the liquid-crystalline birefringent material and the polyvinyl alcohol material into or with a solution of the matrix component. In the case where the dichroic light-absorbing material is also dispersed, the method of preparation may be a method of simultaneously mixing the material for forming the matrix, the liquid-crystalline birefringent material, and the polyvinyl alcohol material and the dichroic light-absorbing material or may be a method including the processes of previously melting and kneading the polyvinyl alcohol resin material and the dichroic light-absorbing material and then freshly kneading the mixture with the material for forming the matrix and the liquid-crystalline birefringent material. It will be understood that the method of preparation is not limited to these methods and may be any other appropriate method.

The amount of the liquid-crystalline birefringent material to be dispersed in the matrix is typically, but not limited to, from 0.01 to 100 parts by weight, preferably from 0.1 to 10 parts by weight, based on 100 parts by weight of the optically-transparent resin. The amount of the polyvinyl alcohol resin material to be dispersed in the matrix is typically, but not limited to, from 0.001 to 5000 parts by weight, preferably from 0.1 to 1000 parts by weight, based on 100 parts by weight of the optically-transparent resin.

The liquid-crystalline birefringent material and the polyvinyl alcohol resin material to be used may or may not be dissolved in a solvent. Examples of the solvent include water, toluene, xylene, hexane, cyclohexane, dichloromethane, trichloromethane, dichloroethane, trichloroethane, tetrachloroethane, trichloroethylene, methyl ethyl ketone, methyl isobutyl ketone, cyclohexanone, cyclopentanone, tetrahydrofuran, and ethyl acetate. When the solution is prepared, the solvent for the matrix component may be the same as or different from the solvent for the liquid-crystalline birefringent material and the polyvinyl alcohol resin material.

In addition, a solution or a molten resin of a matrix component, a solution or a molten resin of a liquid-crystalline birefringent material or polyvinyl alcohol resin material, or a mixed solution or a mixed molten resin thereof may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the process (2) for obtaining a film of the mixed solution or the mixed molten resin, when the mixed solution is used, the mixed solution is heated and dried to remove solvents, and thus a film with at least two types of minute domains dispersed in the matrix is produced. As methods for formation of the film, various kinds of methods, such as casting methods, extrusion methods, injection molding methods, roll molding methods, and flow casting molding methods, may be adopted. When the mixed molten resin is used, a variety of methods may be used such as rolling of the molten resin itself, extrusion molding, injection molding, roll forming, and casting.

In film molding, a size of minute domains in the film is controlled to be in a range of 0.05 to 500 μm in an Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying. For example, a mixed solution of an optically-transparent water-soluble resin that has a high viscosity and generates high shearing force and that forms a matrix, and a liquid crystalline material forming minute domains is dispersed by agitators, such as a homogeneous mixer, being heated at a temperature in no less than a range of a liquid crystal temperature, and thereby minute domains may be dispersed in a smaller state.

The process (3) giving orientation to the above-mentioned film may be performed by stretching the film. In stretching, uniaxial stretching, biaxial stretching, diagonal stretching are exemplified, but uniaxial stretching is usually performed. Any of dries type stretching in air and wet type stretching in an aqueous system bath may be adopted as the stretching method. When adopting a wet type stretching, an aqueous system bath may include suitable additives. A stretching ratio is not especially limited, and in usual a ratio of approximately 2 to 10 times is preferably adopted.

This stretching may orient the dichroic light-absorbing material in a direction of stretching axis. Moreover, the liquid crystalline material forming a liquid-crystalline birefringent material is oriented in the stretching direction in minute domains by the above-mentioned stretching, and as a result birefringence is demonstrated.

It is desirable the minute domains may be deformed according to stretching. When minute domains are of non-liquid crystalline materials, approximate temperatures of glass transition temperatures of the resins are desirably selected as stretching temperatures, and when the minute domains are of liquid-crystalline birefringent materials, temperatures making the liquid crystalline materials exist in a liquid crystal state such as nematic phase or smectic phase or an isotropic phase state, are desirably selected as stretching temperatures. When inadequate orientation is given by stretching process, processes, such as heating orientation treatment, may separately be added.

In addition to the above-mentioned stretching, function of external fields, such as electric field and magnetic field, may be used for orientation of the liquid-crystalline birefringent material. Moreover, the liquid-crystalline birefringent materials mixed with light reactive substances, such as azobenzene, and the liquid-crystalline birefringent materials having light reactive groups, such as a cinnamoyl group, introduced thereto are used, and thereby these materials may be oriented by orientation processing with light irradiation etc. Furthermore, a stretching processing and the above-mentioned orientation processing may also be used in combination. When the liquid-crystalline birefringent material is of liquid crystalline thermoplastic resins, it is oriented at the time of stretching, cooled at room temperatures, and thereby orientation is fixed and stabilized. For example, the process of curing the liquid-crystalline monomer may include the processes of dispersing a mixture of the liquid-crystalline monomer and a photopolymerization initiator into a solution of the matrix component, orienting the monomer, and then curing the monomer by irradiation with ultraviolet light or the like at any timing to stabilize the alignment.

After the process (2) of forming a film, the process (4) of dispersing (or dyeing) the dichroic light-absorbing material into minute domains formed of the polyvinyl alcohol resin material may be performed as needed. For example, the process (4) may be performed by a method of immersing the film in a bath of a solution of the dichroic light-absorbing material in a solvent or by a method of coating the film with a solution that contains the dichroic light-absorbing material. The timing of the immersion may be before or after the stretching process (3). In this process, the concentration of the dichroic dye solution, the use of auxiliary agents, or the like may be selected in any appropriate manner.

A percentage of the dichroic light-absorbing material in the polarizer obtained is not especially limited, but a percentage of the optically-transparent water-soluble resin and the dichroic light-absorbing material are preferably controlled so that the dichroic light-absorbing material is 0.05 to 100 parts by weight based to the optically-transparent water-soluble resin 100 parts by weight, and more preferably 0.1 to 50 parts by weight.

In production of the polarizer, processes for various purposes (5) may be given other than the above-mentioned processes (1) to (4). As a process (5), for example, a process in which a film is immersed in solvent and swollen may be mentioned for the purpose of mainly improving dyeing efficiency of the film. A process in which a film is immersed in a solution including additives or is contained additives, for the purpose of cross-linking a water-soluble resin (matrix), or for the purpose adjusting an amount balance of the dispersed dichroic light-absorbing materials, and adjusting a hue, may be mentioned.

As for the process (3) of orienting (stretching) of the above-mentioned film, the process (4) of dispersing and dyeing the dichroic light-absorbing material into the polyvinyl alcohol resin material forming minute domains and the above-mentioned process (5), respectively, a number, order and conditions (a bath temperature, immersion period of time, etc.) of the processes, may arbitrarily be selected, each process may separately be performed and furthermore a plurality of processes may simultaneously be performed. After a dichroic light-absorbing material is previously dispersed in the process (1), a dichroic light-absorbing material may also be dispersed for dyeing in the process (4). In this case, the processes (1) and (4) may be the same or different in the type of dichroic light-absorbing material.

A film given the above treatments is desirably dried using suitable conditions. Drying is performed according to conventional methods.

A thickness of the obtained polarizer (film) is not especially limited, in general, but it is 1 μm to 5 mm, preferably 5 μm to 3 mm, and more preferably 10 μm to 1 mm.

A polarizer obtained in this way does not especially have a relationship in size between a refractive index of the liquid-crystalline birefringent material forming minute domains and a refractive index of the matrix resin in a stretching direction, whose stretching direction is in an Δn¹ direction and two directions perpendicular to a stretching axis are Δn² directions. Moreover, the stretching direction of a dichroic light-absorbing material is in a direction demonstrating maximal absorption, and thus a polarizer having a maximally demonstrated effect of absorption and scattering may be realized.

Since a polarizer obtained by this invention has equivalent functions as in existing absorbed type polarizing plates, it may be used in various applicable fields where absorbed type polarizing plates are used without any change.

The above-obtained polarizer may be just used as a polarizing plate since the matrix is not made of polyvinyl alcohol resin, or may be used as a polarizing plate with a transparent protective layer prepared at least on one side thereof as needed. The transparent protective layer may be prepared as an application layer by polymers, or a laminated layer of films. Proper transparent materials may be used as a transparent polymer or a film material that forms the transparent protective layer, and the material having outstanding transparency, mechanical strength, heat stability and outstanding moisture interception property, etc. may be preferably used. As materials of the above-mentioned protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

As a transparent protective film, if polarization property and durability are taken into consideration, especially triacetyl cellulose film whose surface is saponified with alkaline is preferable. In general, a thickness of a transparent protective film is 500 μm or less, preferably 1 to 300 μm, and especially preferably 5 to 300 μm. In addition, when transparent protective films are provided on both sides of the polarizer, transparent protective films comprising same polymer material may be used on both of a front side and a back side, and transparent protective films comprising different polymer materials etc. may be used.

Moreover, it is preferable that the transparent protective film may have as little coloring as possible. Accordingly, a protective film having a retardation value in a film thickness direction represented by Rth=[(nx+ny)/2−nz]×d of −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protective film may mostly be cancelled using a protective film having a retardation value (Rth) of −90 nm to +75 nm in a thickness direction. The retardation value (Rth) in a thickness direction is preferably −80 nm to +60 nm, and especially preferably −70 nm to +45 nm.

A hard coat layer may be prepared, or antireflection processing, processing aiming at sticking prevention, diffusion or anti glare may be performed onto the face on which the polarizer of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Adhesives are used for adhesion processing of the above described polarizer and the transparent protective film. As adhesives, isocyanate derived adhesives, polyvinyl alcohol derived adhesives, gelatin derived adhesives, vinyl polymers derived latex type, aqueous polyesters derived adhesives, etc. may be mentioned. The above-described adhesives are usually used as adhesives comprising aqueous solution, and usually contain solid of 0.5 to 60% by weight.

A polarizing plate of the present invention is manufactured by adhering the above described transparent protective film and the polarizer using the above described adhesives. The application of adhesives may be performed to any of the transparent protective film or the polarizer, and may be performed to both of them. After adhered, drying process is given and the adhesion layer comprising applied dry layer is formed. Adhering process of the polarizer and the transparent protective film may be performed using a roll laminator etc. Although a thickness of the adhesion layer is not especially limited, it is usually approximately 0.1 to 5 μm.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyarylates and polyamides; oriented films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal bidirectional stretching and a bidirectionally stretched film as inclined orientation film etc. may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

A polarizing plate or an optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, a polarizing plate or an optical film and, if necessity, lighting system, and by incorporating driving circuit. In the present invention, except that a polarizing plate or an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the polarizing plate or the optical film has been located at one side or both sides of the liquid crystal cell, and with which a backlight or a reflector is used for a lighting system may be manufactured. In this case, the polarizing plate or the optical film by the present invention may be installed in one side or both sides of the liquid crystal cell. When installing the polarizing plate or the optical film in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

### EXAMPLES

The invention is more specifically described below by showing some examples according to the invention. Hereinafter, the term “part” or “parts” means part or parts by weight.

### Example 1

At 220° C., 100 parts of a polyethylene-modified polyvinyl alcohol resin with a degree of polymerization of 500 (Exceval RS-4105 manufactured by Kuraray Co., Ltd.) and 17 parts of a hydrophilic dichroic dye (INK GREY B manufactured by Clariant Japan K.K.) were molten and kneaded, and the mixture was formed into pellets using a pelletizer. On the other hand, 100 parts of a cycloolefin resin (TOPAS manufactured by Ticona) and 5 parts of the liquid crystal polymer represented by the formula:

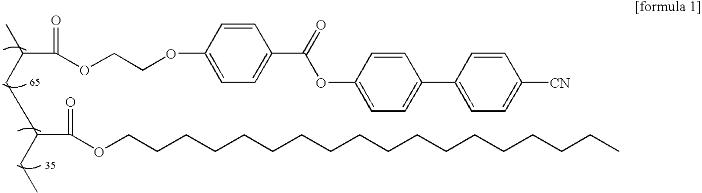

wherein a block polymer is shown for convenience in drawing and it has a weight average molecular weight of 5000, were molten and kneaded at 250° C., and the mixture was formed into pellets using a pelletizer. A 200 μm-thick film was formed by extruding 100 parts of the cycloolefin resin-containing pellets and 30 parts of the polyvinyl alcohol resin-containing pellets with a biaxial extruder (at a die temperature of 240° C.). The resulting film was stretched six times by a dry stretching method (170° C.) to give a polarizer according to the invention.

### (Determination of Anisotropic Scattering and Measurement of Refractive Index)

As a result of observing the resulting polarizer with a polarization microscope, it has been recognized that countless minute domains are formed of the liquid crystal polymer and the polyvinyl alcohol, respectively, and dispersed in the cycloolefin resin. The liquid crystal polymer was oriented in the stretching direction, and the minute domains had an average size of 5 to 10 μm in the stretching direction (Δn¹ direction) and an average size of 0.5 to 3 μm in the direction (Δn² direction) perpendicular to the stretching direction.

The refractive indices of the matrix and the minute domains of the liquid crystal polymer were measured each independently. Measurement was conducted at 20° C. Initially, the refractive index of the cycloolefin resin itself stretched under the same stretching conditions was measured with an Abbe refractometer (light for measurement: 589 nm). The results were as follows: the refractive index in the stretching direction (Δn¹ direction)=1.53 and the refractive index in the Δn² direction=1.53. The refractive index (ne: extraordinary index and no: ordinary index) of the liquid crystal polymer was also measured. A high refractive index glass was subjected to vertical alignment treatment, and the liquid-crystalline monomer was applied to the treated glass to be aligned and then measured for no with an Abbe refractometer (light for measurement: 589 nm). On the other hand, a liquid crystal cell, which had been subjected to horizontal alignment treatment, was filled with the liquid-crystalline monomer and then measured for retardation (Δn·d) with an automatic birefringence measurement system (Automatic Birefringence Analyzer KOBRA 21ADH manufactured by Oji Scientific Instruments). Separately, the cell gap (d) was measured by optical interferometry. An was calculated from the retardation and the cell gap (the retardation/the cell gap), and ne was calculated as the sum of Δn and no. The results was as follows: ne (corresponding to the refractive index in the Δn¹ direction)=1.72 and no (corresponding to the refractive index in the Δn² direction)=1.53. Thus, the following were calculated: Δn¹=1.72−1.53=0.19 and Δn²=1.53−1.53=0. From the foregoing, the occurrence of anisotropic scattering has been demonstrated.

### Comparative Example 1

An aqueous 10% by weight solution containing 850 parts of a polyvinyl alcohol resin, 100 parts of the liquid crystal polymer as used in Example 1, and a 10% by weight toluene solution containing 50 parts of an absorbing dichroic dye (M86 manufactured by Mitsui Chemicals, Inc.) were stirred and mixed in a homomixer, and the resulting mixture was formed into an 80 μm-thick film by casting. Both solvents, water and toluene, were sufficiently removed by drying, and then the film was stretched twice at 160° C. and then stretched six times at 160° C. The stretched film was rapidly cooled, resulting in a polarizer.

### (Evaluation of Optical Characteristics)

Polarizers (samples) obtained in Example 1 and Comparative example 1 were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard calorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction.

A polarization degree P was calculated with an equation P={(k₁−k₂)/(k₁+k₂)}×100. A transmittance T of a simple substance was calculated with an equation T=(k₁+k₂)/2.

In haze values, a haze value to a linearly polarized light in a maximum transmittance direction, and a haze value to a linearly polarized light in an absorption direction (a perpendicular direction). Measurement of a haze value was performed according to JIS K7136 (how to obtain a haze of plastics-transparent material), using a haze meter (manufactured by Murakami Color Research Institute HM-150). A commercially available polarizing plate (NPF-SEG1224DU manufactured by NITTO DENKO CORP.: 43% of simple substance transmittances, 99.96% of polarization degree) was arranged on a plane of incident side of a measurement light of a sample, and stretching directions of the commercially available polarizing plate and the sample (polarizer) were made to perpendicularly intersect, and a haze value was measured. However, since quantity of light at the time of rectangular crossing is less than limitations of sensitivity of a detecting element when a light source of the commercially available haze meter is used, light by a halogen lamp which has high optical intensity provided separately was made to enter with a help of an optical fiber device, thereby quantity of light was set as inside of sensitivity of detection, and subsequently a shutter closing and opening motion was manually performed to obtain a haze value to be calculated. In evaluation of unevenness, in a dark room, a sample (polarizer) was arranged on an upper surface of a backlight used for a liquid crystal display, furthermore, a commercially available polarizing plate (NPF-SEG1224DU by NITTO DENKO CORP.) was laminated as an analyzer so that a polarized light axis may intersect perpendicularly. And a level of the unevenness was visually observed on following criterion using the arrangement.

x: a level in which unevenness may visually be recognized
O: a level in which unevenness may not visually be recognized

TABLE 1

| | Transmittance of linearly | | | | | | |
|---|---|---|---|---|---|---|---|
| | polarized light (%) | | Simple | | Haze Value (%) | | |
| | Maximum | | substance | | Maximum | | |
| | Transmission | Perpendicular | Transmittance | Polarization | Transmission | Perpendicular | Stretching |
| Polarizer | Direction (k₁) | Direction (k₂) | (%) | degree (%) | Direction | Direction | Unevenness |
| Example 1 | 86.8 | 0.04 | 43.4 | 99.9 | 1.7 | 82.0 | ∘ |
| Comparative | 86.5 | 0.04 | 43.3 | 99.9 | 1.5 | 82.0 | ∘ |
| Example 1 | | | | | | | |

Table 1 shows that Example 1 provides a good transmittance and a high polarization degree and produces no stretching unevenness.

### (Heat Resistance/Moisture Resistance)

A polarizing plate was prepared by bonding 80 μm-thick triacetylcellulose films (serving as protective films) to both sides of a cut piece (25 mm×50 mm in size) of the polarizer through a polyurethane adhesive. The polarizing plate was adhered to a slide glass with an acrylic pressure-sensitive adhesive and then measured for initial optical properties (simple substance transmittance and polarization degree). Thereafter, the polarizing plate was subjected to a heat resistance test in which the polarizing plate was placed in a drying oven at 80° C. for 1000 hours. Separately, the polarizing plate was subjected to a moisture resistance test in which the polarizing plate was placed in a thermo-hygrostat at 60° C. and 95% RH for 1000 hours. The optical properties of the polarizing plate after the heat resistance test and those after the moisture resistance test were measured, respectively, and the amount of the change that is the value after the test—the initial value was calculated. The results are shown in Table 2.

In the heat resistance test, the amount of the change in polarization degree (%) is preferably within ±2%, more preferably at most ±1%, so that there can be provided good polarizing plates or optical films with heat resistance. In the moisture resistance test, the amount of the change in polarization degree (%) is preferably at most ±3%, more preferably at most ±2%, so that there can be provided good polarizing plates or optical films with moisture resistance.

TABLE 2

| | Heat Resistance | | Moisture Resistance | |
|---|---|---|---|---|
| | Amount of | | Amount of | |
| | Change in | Amount of | Change in | Amount of |
| | Simple | Change in | Simple | Change in |
| | Substance | Polarization | Substance | Polarization |
| | Transmittance (%) | degree (%) | Transmittance (%) | degree (%) |
| Example 1 | 0.5 | −0.1 | 0.7 | −0.2 |
| Comparative | 1.8 | −2.2 | 2.9 | −3.2 |
| Example 1 | | | | |

### INDUSTRIAL APPLICABILITY

The polarizer of the invention, and polarizing plates and optical films each using the polarizer of the invention are suitable for use in image displays such as liquid crystal displays, organic electro-luminescent displays, CRTs, and PDPs.

1. A polarizer, comprising:
a monolayer film that has a structure having at least two types of minute domains dispersed in a matrix formed of an optically-transparent water-soluble resin, wherein
at least one of the minute domains is formed of a liquid-crystalline birefringent material, and
at least one of the other type or types of the minute domains is formed of a polyvinyl alcohol resin material containing a dichroic light-absorbing material that does not lose its dichroism within the liquid crystal temperature range of the liquid-crystalline birefringent material.

2. The polarizer according to claim 1, wherein the liquid-crystalline birefringent material forming the minute domain is oriented.

3. The polarizer according to claim 2, wherein the liquid-crystalline birefringent material shows liquid crystalline at least in orientation processing step.

4. The polarizer according to claim 2, wherein the liquid-crystalline birefringent material has 0.02 or more of birefringence.

5. The polarizer according to claim 2, wherein in a refractive index difference between the liquid-crystalline birefringent material forming the minute domain and the optically-transparent water-soluble resin in each optical axis direction,
a refractive index difference (Δn¹) in direction of axis showing a maximum is 0.03 or more, and
a refractive index difference (Δn²) between the Δn¹ direction and a direction of axes of two directions perpendicular to the Δn¹ direction is 50% or less of the Δn¹.

6. The polarizer according to claim 5, wherein an absorption axis of the dichroic light-absorbing material contained in the polyvinyl alcohol resin material forming the minute domain is oriented in the Δn¹ direction.

7. The polarizer according to claim 1, wherein the film is manufactured by stretching.

8. The polarizer according to claim 5, wherein the minute domain has a length of 0.05 to 500 μm in the Δn² direction.

9. The polarizer according to claim 1, wherein a dichroic light-absorbing material has an absorbing band at least in a band of 400 to 700 nm wavelength range.

10. The polarizer according to claim 1, wherein a transmittance to a linearly polarized light in a transmission direction is 70% or more,
a haze value is 10% or less, and
a haze value to a linearly polarized light in an absorption direction is 30% or more.

11. A polarizing plate in which a transparent protective layer is not prepared on the polarizer according to claim 1.

12. A polarizing plate in which a transparent protective layer is prepared at least on one side of the polarizer according to claim 1.

13. An optical film comprising at least one of the polarizer according to claim 1.

14. An image display comprising the polarizer according to claim 1.

15. An image display comprising the polarizing plate according to claim 12.

16. An image display comprising and the optical film according to claim 13.
